(19) United States
(12) Patent Application Publication
(10) Pub. No.: US 2024/0338197 A1
(43) Pub. Date: Oct. 10, 2024

(54) Method and apparatus for anti-rollback protection for non-persistent software

(71) Applicant: Intel Corporation, Santa Clara, CA (US)

(72) Inventors: Dan HOROVITZ, Rishon Lezion (IL); Igor METRIK, MEVASERET ZION (IL); Omer BEN-SHALOM, Rishon Le-Tzion (IL); Ilil BLUM SHEM-TOV, Kiryat Tivon (IL); Ofer RIVLIN, Tel-Aviv (IL)

(21) Appl. No.: 18/393,733

(22) Filed: Dec. 22, 2023

(51) Int. Cl. G06F 8/65; G06F 8/61

(52) U.S. Cl. CPC G06F 8/65; G06F 8/62

(57) ABSTRACT

A method and apparatus for anti-rollback protection for a non-persistent software in a system. A software install package includes a main version of software and a fallback version of the software. The fallback version of the software includes a vulnerable versions list that includes a list of vulnerable versions of the software determined up to a release date of the fallback version of the software. The fallback version of the software is stored in the system. The main version of the software is installed if the main version of the software is not listed in the vulnerable versions list. The fallback version may be updated automatically if the new fallback version higher than the existing fallback version is received. The fallback version is stored in a fallback versions' repository by an operating system or installer. The fallback version may include an allowed versions list.

### BACKGROUND

Many hardware (HW) components or software (SW) applications are using non-persistent firmware (FW) or SW loaded by their SW drivers, SW tools, or installers at boot time or at initialization phase (at first use) or by need. A non-persistent FW can be considered as an extended SW part that runs on the HW device. If a non-persistent FW has been compromised or tampered (e.g., by exploitable vulnerabilities), it may allow an attacker to elevate their privileges from the SW or system to the FW and through lateral movements to other FW intellectual properties (IPs) or HW blocks. That type of FW is also a good place to hide malicious code execution or even execute it. Anti-viruses and endpoint detection and response (EDR) may not detect it as it is not a regular operating system (OS) executable, and it is loaded in a HW IP that can impact the platforms and the OS. Currently there is no good solution to prevent rollback (i.e., anti-roll back (ARB)) of such FW, SW, or drivers to a vulnerable previous version.

### BRIEF DESCRIPTION OF THE FIGURES

Some examples of apparatuses and/or methods will be described in the following by way of example only, and with reference to the accompanying figures, in which

FIG. 1 is a schematic diagram of an apparatus for anti-rollback protection for a persistent SW/FW;

FIG. 2 is an example signal flow diagram for anti-rollback protection against a rollback attack in accordance with an example scheme disclosed herein;

FIG. 3 is a flow diagram of an example process for anti-rollback protection for a non-persistent software in a system;

FIG. 4 is a flow diagram of an example process for anti-rollback protection for a non-persistent software in a system;

FIG. 5 is a block diagram of an electronic apparatus incorporating at least one electronic assembly and/or method described herein;

FIG. 6 illustrates a computing device in accordance with one implementation of the invention; and

FIG. 7 is included to show an example of a higher-level device application for the disclosed embodiments.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e. only A, only B as well as A and B. An alternative wording for the same combinations is “at least one of A and B”. The same applies for combinations of more than 2 elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

In the following description, specific details are set forth, but examples of the technologies described herein may be practiced without these specific details. Well-known circuits, structures, and techniques have not been shown in detail to avoid obscuring an understanding of this description. “An example,” “various examples,” “some examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, cither temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform or resource, even though the instructions contained in the software or firmware are not actively being executed by the system, device, platform, or resource.

The description may use the phrases “in an example,” “in examples,” “in some examples,” and/or “in various examples,” each of which may refer to one or more of the same or different examples. Furthermore, the terms “comprising,” “including,” “having,” and the like, as used with respect to examples of the present disclosure, are synonymous.

A non-persistent SW or FW may be installed and re-installed by need or via a mechanism controlled by a user (e.g., after every restart, etc.). A non-persistent SW/FW is a SW/FW that can be installed, re-installed, or uninstalled by a user or automatically through a pre-defined mechanism controlled by a user, SW providers, original equipment manufacturers (OEMs), original design manufacturers (ODMs), etc. A driver, a SW tool, or an installer may load a non-persistent SW/FW per need before its use. A rollback to a previous version of SW/FW may be performed. Currently there is no anti-rollback (ARB) mechanism for a non-persistent SW/FW as the users can control what version of SW/FW is installed at the OS level, and for usability or system functionality, the OS or their delivery mechanism allows downgrade to a lower version of SW/FW. Anti rollback contradicts with system usability and system functionality. Today, if one is fully enforced then the other is impacted. Attackers can exploit this to download a malicious (previous) version of SW/FW and then to abuse the system.

In Windows OS, there is a possibility to do a rollback of a driver (including FW) through certificate revocation of the driver. This mechanism requires connectivity to OS vendor DB and cannot be enforced in isolated systems. The certificate revocation will deny a driver install/load and a bundled FW update. If the certificate is in the revocation list managed by the OS vendor, the driver will not load. If this mechanism is used, it will lead to a lack of critical functionalities in the system as the revoked driver will not function at all. The mechanism implemented is partially used due to usability and functionality impact.

Alternatively, a secure boot with a signed “monolithic image” concept may be used. A driver is compiled as part of kernel and is not loadable and cannot be updated without update of the entire kernel image with no control of the image loading (e.g., Chrome OS). Signed images are good as long as the secure boot is enabled, and driver's FW/SW will not be tampered after the secure boot. Vendor decides which image is the latest and most secure and will not always release new versions for a specific SW/FW/driver. Android from approved market only allows the latest versions.

Alternatively, FW may be made persistent and be updated only with an approved version, controlled by a BootROM type of mechanism. This will always keep a valid FW version on a persistent device storage. However, not all IPs benefit from the persistent storage because of increased bill of material (BOM) or other constraints. This scheme does not address non-persistent use cases.

Antiroll-back includes two steps: detection of a vulnerable roll-backed SW/FW version and a rollback mechanism to a secure SW/FW version. In examples, the delivery mechanism (e.g., operating system) keeps a fallback version of the SW/FW package to be installed or updated, and in case the proposed SW/FW version is determined to be vulnerable the delivery mechanism will deny the install or update and may automatically recover to the fallback version of the SW/FW.

Currently there is no such mechanism at the SW level. In accordance with the example schemes disclosed herein, anti-rollback protection can be provided for SW/FW packages, and users can benefit from better security. The example schemes disclosed herein are applicable to any system that lacks persistent memory and loads FW/SW each time the FW/SW is invoked, activated, or used. The example schemes disclosed herein are applicable to any system that supports SW/FW rollback based on user decision or automatically to maintain user interface or legacy functionality. The example schemes disclosed herein can work either online or off-line. The example schemes disclosed herein can work in off-line systems where there is no option to get automatic updates and the system owner cannot rely on automatic SW/FW updates to keep the system up to date. The example schemes disclosed herein provide better security and are aligned with the security defense, i.e., adding a new protection layer that is not currently available.

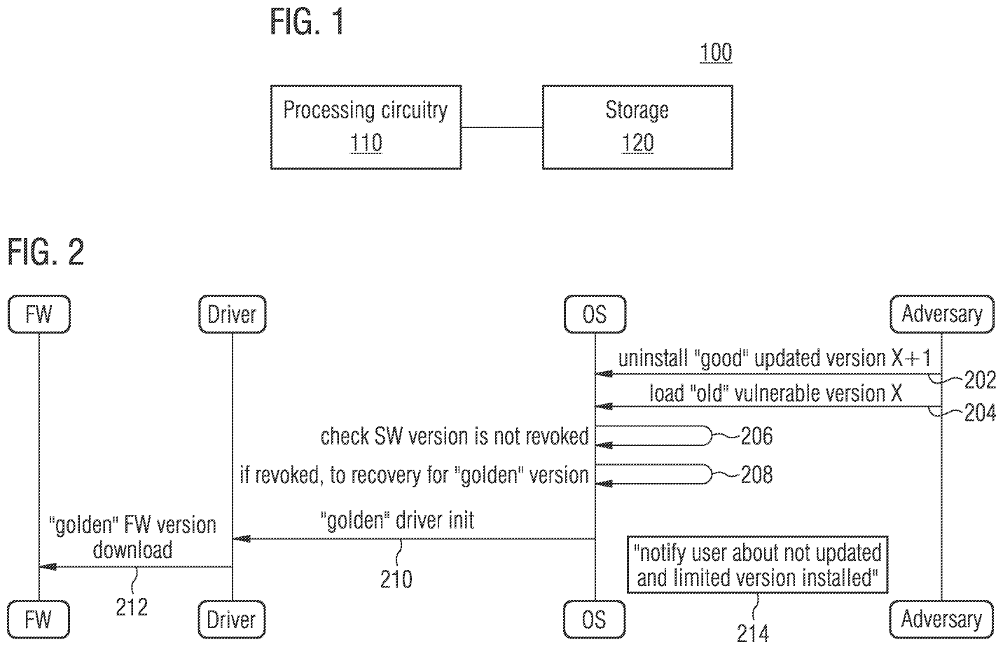

Examples for anti-rollback protection for a persistent SW/FW will be explained hereafter. FIG. 1 is a schematic diagram of an apparatus for anti-rollback protection for a persistent SW/FW. Hereafter, the term “SW” will be used inclusive of “FW.” The apparatus 100 includes a processing circuitry 110 and a storage 120. The processing circuitry 110 may be configured to receive a software install package. The software install package includes a main version of software and a fallback version of the software. In examples, each SW installation package includes a fallback version in addition to a main version. Every installed SW package has a fallback version. The fallback version of the SW is used to roll back in case where a vulnerability is detected in the existing SW versions. The fallback version of the software includes a vulnerable versions list that includes a list of vulnerable versions of the software determined up to a release date of the fallback version of the software. The storage 120 may be configured to store the fallback version of the software. The processing circuitry 110 may be configured to install the main version of the software if the main version of the software is not listed in the vulnerable versions list.

The processing circuitry 110 may be configured to receive a second software install package for upgrade or downgrade. The second software install package includes a second main version of the software and a second fallback version of the software. The second fallback version of the software includes a second vulnerable versions list that includes a list of vulnerable versions of the software determined up to a release date of the second fallback version of the software. The second fallback version may or may not be same as the first fallback version. The processing circuitry 110 may be configured to update the fallback version of the software stored in the system if the second fallback version of the software is a higher version than the fallback version of the software stored in the system, and make no change to the fallback version of the software stored in the system if the second fallback version of the software is not a higher version than the fallback version of the software stored in the system.

The processing circuitry 110 may be configured to install the second main version of the software if the second main version of the software is not included in the vulnerable versions list, which was included in a higher version of the fallback version, either stored in the system or received in the new package and may not install the second main version of the software if the second main version of the software is included in the vulnerable versions list. Alternatively, the processing circuitry 110 may be configured to install the fallback version of the software if the main version of the software is listed in the vulnerable versions list.

The processing circuitry 110 may be configured to uninstall the main version of the software. In this case, the fallback version remains in the system without any change after uninstalling the main version of the software.

The fallback version of the software may be stored in a fallback versions' repository in the storage 120 by an operating system or by a delivery mechanism. In some examples, the fallback version of the software may be stored in a secure storage in hardware or at operating system-protected registry hive.

In some examples, the fallback version of the software may further include an allowed versions list that indicates a version(s) of the software that is allowed to be installed. In this case, the processing circuitry 110 may be configured to install the main version of the software only if the main version of the software is included in the allowed versions list.

In some examples, the software install package may be signed by a digital signature, and the main version of the software and the fallback version of the software may also be each signed by a separate digital signature. The processing circuitry 110 may be configured to install the main version of the software and store the fallback version in the system if the software install package, the main version of the software, and the fallback version of the software are all verified by the respective digital signature.

Examples for anti-rollback protection for non-persistent SW/FW will be explained in detail hereafter. The examples disclosed herein may be explained with reference to SW, drivers, or installers that are responsible for SW/FW update but can be extended to any SW packages. A SW package includes a set of software programs bundled together and may also include an installer for installing the software programs. In examples, every SW/FW install package includes a main version (i.e., the desired version) of the SW/FW package and a fallback version of the SW/FW. Both versions (i.e., the desired version and the fallback version) are embedded in a single SW/FW install package. The fallback version of the SW/FW is used to roll back in case where a vulnerability is detected in the existing SW/FW versions. The fallback version may include limited functionalities compared to the main version. The fallback version included in the same SW package may be in the same generation as the main version. The example schemed disclosed herein do not rely on centralized depository and may work with or without network connections. The example schemes disclosed herein are applicable to any OS including Windows OS, Linux, Chrome, or any other operating systems.

In addition, the fallback version of the SW/FW included in each SW/FW install package includes a vulnerable versions list. The vulnerable versions list may be meta data included in the fallback version. The vulnerable versions list includes/indicates all vulnerable versions of the SW/FW that have been detected up to the date that the fallback version is released. SW vendors will release new fallback versions as they release new fixes to the existing vulnerable versions of the SW/FW. The vulnerable versions list will include all the new vulnerable versions in the field. The vulnerable versions list may be updated by a newer fallback version.

If a new version of SW/FW is installed in a system, the new SW/FW install package may contain a new fallback version with an updated vulnerable versions list. In that case, users will not be able to downgrade to a vulnerable fallback version as long as they do not rebuild the whole system. The fallback version may not be rolled back to a lower fallback version, but only upgraded to a higher version. If a new fallback version is available for update in the system, the system updates the new fallback version either manually or automatically. The system in accordance with the examples disclosed herein allows only progressing towards a more secure version (fallback version) of the SW/FW and do not degrade the system security unintentionally or intentionally by an attacker.

The SW/FW install package may include a digital signature. A digital signature is applied to a software binary or file. The digital signature validates the identity of the software author or publisher and verifies that the file has not been altered or tampered with since the digital signature was signed. A SW/FW package with a valid digital signature ensures that the SW/FW package has not been modified or altered since the digital signature was applied to the SW/FW package. Using SW/FW packages with a digital signature, SW/FW packages can be securely downloaded and added to the system because the digital signature can be verified before the SW/FW packages are added to the system. In examples, a SW/FW package including a main version and a fallback version may be digitally signed. In addition, each part of the main and fallback versions may be digitally signed separately so that the integrity and authenticity of the SW/FW install package and each part of the main and fallback versions can be verified and attested. For example, a digitally signed SW/FW package may contain (SW|FW package+unique version) (signed) and (SW|FW fallback package+unique version+vulnerable versions list) (signed).

In examples, the fallback version of the SW/FW received via the SW/FW install package is stored in a fallback versions' repository (ARB repository) in the system. In one example, the OS may manage the SW/FW packages availability. In this case, the OS is relied on to manage the fallback versions' repository. Alternatively, the OS may not be relied on to manage the fallback versions' repository. In this case, a secure storage (e.g., a HW-based storage) may be used to keep the fallback version of each installed SW/FW package.

In one example, the OS of the system may manage the SW/FW install packages availability. The OS vendor may want to maintain system functionality even if the user unintentionally or maliciously tries to downgrade the system to a vulnerable version. Once a SW/FW package is installed in a system either by the OS or by its delivery mechanism (e.g., an installer, a driver, etc.), the fallback version of the SW/FW is stored in the fallback versions' repository and remains in the system until the OS is re-installed from scratch (not upgraded). The fallback version of the SW/FW can be updated either manually or through automatic update in case the system supports it.

For the first time installation of SW/FW, a SW/FW install package for a specific version will be received by the system (apparatus). The SW/FW install package includes a main version and a fallback version, and the fallback version includes a vulnerable versions list. The fallback version of the SW/FW included in the SW/FW install package is added into the fallback versions' repository by the delivery mechanism or the system (e.g., an OS). The fallback version includes a vulnerable versions list. The vulnerable version list includes/indicates all vulnerable versions of the SW/FW up to the release date of the fallback version. If the main version of the received SW/FW install package is determined to be safe (not vulnerable) (e.g., the vulnerable version list does not include the main version), the main version is installed. If the main version of the received SW/FW install package is determined to be vulnerable (e.g., the vulnerable version list includes the main version), the main version is not installed and instead the fallback version may be installed (e.g., depending on the user's input). For the first-time installation, the system will just store the fallback version. For subsequent updates, the fallback version will be updated only if the received fallback version is newer than the one stored in the system.

The SW/FW vendor will digitally sign the SW/FW package and each part of the package (i.e., the main and fallback versions) separately, and will provide a fallback version of the SW/FW to the OS vendor. The SW/FW vendor will be able to update the OS vendor with a new and more secure fallback version of the SW/FW and with the versions that should be revoked due to security reasons. For example, the SW/FW vendor may revoke those vulnerable versions of the SW/FW based on a certificate revocation mechanism or any other revocation mechanism that the OS vendor supports. Therefore, for the first-time installation of the SW/FW package, the delivery mechanisms at the OS level may load only the digitally-signed and verified, and not revoked SW/FW versions and the vulnerable versions may be denied through their certificate revocation or alternative mechanism supported by the OS.

In case of uninstalling the existing SW/FW, just the active version of the SW/FW on the system is removed and the fallback version remains intact in the system for future use.

For upgrade of the SW/FW, the system receives a SW/FW install package for the upgraded version. The new SW/FW install package includes an upgraded main version and a fallback version of the SW/FW. If the fallback version included in the new SW/FW install package for the upgraded version is newer (higher) than the fallback version stored in the system, the fallback version is updated, either manually or automatically. If the fallback version included in the new SW/FW install package for the upgraded version has the same version as the existing fallback version stored in the system, no change may be made to the fallback version existing in the system.

The system then checks whether the upgraded main version of the SW/FW is vulnerable. The vulnerability of the new main version may be determined by checking the vulnerable versions list included in the new fallback version (or the existing fallback version if the fallback version is not updated). If the upgraded main version is determined to be not vulnerable (e.g., the upgraded main version is not included in the vulnerable versions list), then the upgraded main version is installed. If the upgraded main version is determined to be vulnerable (e.g., the upgraded main version is included in the vulnerable versions list), the upgraded main version is not installed (i.e., upgrade is not performed).

For downgrade of the SW/FW, the system receives another SW/FW install package for the lower version of the SW/FW. The SW/FW install package includes a downgraded main version of the SW/FW and a fallback version of the SW/FW. The system checks whether the downgraded main version of the SW/FW is vulnerable. The vulnerability of the downgraded main version may be determined by checking the vulnerable versions list included in the fallback version stored in the system (or the fallback version received in the new SW/FW install package if the received version is higher).

If the downgraded main version is determined to be not vulnerable (e.g., the downgraded main version is not included in the vulnerable versions list), then the downgraded main version is installed. If the downgraded main version is determined to be vulnerable (e.g., the downgraded main version is included in the vulnerable versions list), the downgraded main version is not installed (i.e., the downgrade fails). In this case, the system may maintain the existing version, or may install the fallback version (e.g., depending on the user's input). The existing fallback version may remain intact as the downgraded version of the package has either the same fallback version or lower one.

Example scenarios for SW installation, upgrade, and downgrade are explained hereafter. The SW package may have a version in a main.minor format (e.g., 1.2, 3.4, 20.10).

### Example 1

For the first time installation of SW, the system receives a SW install package as follows:
SW install package version 5.3: main version 5.3+fallback version 5.3 including vulnerable versions list (5.2, 5.1, 5.0, 4.1, 4.5, 3.4, 3.3, 2.1).
   In this case, the main version 5.3 will be installed successfully since the version 5.3 is not in the vulnerable versions list assuming that the integrity of the package and each part of the main and fallback versions has been verified by digital signatures. The fallback version 5.3 will be saved in the fallback versions' repository.

Subsequently, the system tries to downgrade to version 4.3. The system receives a SW install package as follows:
SW install package version 4.3: main version 4.3+fallback version 4.3 including vulnerable versions list (4.1, 4.2, 3.4, 3.3, 2.1).
   In this case, the main version 4.3 will be installed successfully since the main version 4.3 is not in the vulnerable versions list included in the fallback version 5.3 (the fallback version currently stored in the system). The fallback version (fallback version 5.3) stored in the system is not changed since it is a higher version, and it is maintained in the fallback versions' repository.

Subsequently the system tries to upgrade to version 4.5. The system receives a SW install package as follows:
SW install package version 4.5: main version 4.5+fallback version 4.5 including vulnerable versions list (4.1, 4.2, 3.4, 3.3, 2.1).
   In this case, the upgrade to main version 4.5 will fail since main version 4.5 is included in the vulnerable versions list that is currently stored in the system (i.e., the one included in the fallback version 5.3). Instead of installing main version 4.5, the system may install fallback version 5.3 or remain with the current main version 4.3 (e.g., based on user's input).

### Example 2

For the first time installation of SW, the system receives a SW install package as follows:
SW install package version 4.3: main version 4.3+fallback version 4.3 including vulnerable versions list (4.1 4.2, 3.4, 3.3, 2.1).
   In this case, the main version 4.3 will be installed successfully since the main version 4.3 is not in the vulnerable versions list assuming that the integrity of the package 4.3 and each part of the main and fallback versions has been verified by digital signatures. The fallback version 4.3 will be saved in the fallback versions' repository.

Subsequently, for upgrade to version 4.5, the system receives a new SW install package as follows:
SW install package version 4.5: main version 4.5+fallback version 4.5 including vulnerable versions list (4.1, 4.2, 4.3, 3.4, 3.3, 2.1).
   In this case, the main version 4.5 will be installed successfully since the main version 4.5 is not in the vulnerable versions list (i.e., the updated vulnerable versions list received in the package version 4.5). The fallback version will also be upgraded to fallback version 4.5 since it is a newer version. The system keeps the new fallback version 4.5 including the new vulnerable versions list.

Subsequently, for downgrade to version 4.3, the system receives another SW install package as follows:
SW install package version 4.3: main version 4.3+fallback version 4.3 including vulnerable versions list (4.1 4.2, 3.4, 3.3, 2.1).
   In this case, the downgrade to main version 4.3 will fail since the main version 4.3 is now listed in the vulnerable versions list that is currently stored in the system, (i.e., the one included in the fallback version 4.5). The fallback version is not updated since fallback version 4.5 is a higher version. After failing to downgrade, the system may install fallback version 4.5 or may keep the main version 4.5 (e.g., based on user's input).

In another examples, a secure storage (e.g., a HW-based storage) in the system may be used to keep the fallback version of each installed SW/FW package. In case where the OS cannot be relied on to manage the fallback versions' repository, a secure storage in HW in the system or at OS-protected registry hive may be used to store the fallback version. The OS-protected registry hive may be a hierarchical database that is used by the OS to store configuration settings, options, etc. In this example, a SW/FW installer controls the management of the fallback version. A SW/FW installer may register the fallback version in the secure storage in the system. This may be done as the delivery mechanism will check the digital signature of the overall SW/FW package and the digital signature of the fallback version and will check if the existing SW/FW package is already registered. In case of first-time installation, the system will just store the fallback version, and for the subsequent update, the fallback version will be updated only if the fallback version is newer than the one stored in the system.

Once the SW/FW package is installed in a system either by the OS or by its delivery mechanism (e.g., an installer, a driver, etc.) the fallback version will remain in the system until the OS is reinstalled from scratch (not upgraded) or forever if stored in HW. The assumption is that the fallback version can be updated either manually or through automatic update in case the system supports it.

For the first time installation of the SW/FW, a SW/FW install package for a specific version will be received by the system. The SW/FW install package includes a main version and a fallback version, and the fallback version includes a vulnerable versions list. The fallback version of the SW/FW included in the SW/FW install package is added into the fallback versions' repository by the delivery mechanism or the system. The fallback version includes a vulnerable versions list. The vulnerable versions list is meta data included in the fallback version of the SW/FW. The vulnerable versions list includes all vulnerable versions of the SW/FW up to the release date of the fallback version. If the main version of the received SW/FW install package is determined to be safe (not vulnerable) (e.g., the vulnerable version list does not include the main version), the main version is installed. If the main version of the received SW/FW install package is determined to be vulnerable (e.g., the vulnerable version list includes the main version), the main version is not installed and instead the fallback version may be installed. For the first-time installation of the SW/FW package, the delivery mechanisms at the OS level may load only the digitally-signed and verified, and not revoked SW/FW versions and the vulnerable versions may be denied through the certificate revocation or alternative mechanism supported by the OS.

For uninstallation of the existing SW/FW, just the active version on the system is removed, and the fallback version remains intact on the system for future use. In case a malicious user manually removes the SW/FW from the system, the malicious user may not be able to update to any vulnerable version that is listed in the fallback versions list that is kept in HW or OS registry (i.e., the HW is protecting against SW system adversary as well, OS registry only protects from a non-system adversary).

For upgrade of the SW/FW, the system receives a SW/FW install package for the upgraded/higher version. The new SW/FW install package includes an upgraded main version and a new fallback version of the SW/FW. If the new fallback version included in the SW/FW install package for the upgraded version is newer/higher than the existing fallback version in the system, the fallback version is updated, either manually or automatically. If the fallback version included in the new SW/FW install package for the upgraded version has the same version as, or lower than, the existing fallback version, no change may be made to the fallback version stored in the system.

The system then checks whether the upgraded main version of the SW/FW is vulnerable. The vulnerability of the new main version may be determined by checking the vulnerable versions list included in the new fallback version (or the existing fallback version if the fallback version is not updated). If the upgraded main version is determined to be not vulnerable (e.g., the upgraded main version is not included in the vulnerable versions list), then the upgraded main version is installed. If the upgraded main version is determined to be vulnerable (e.g., the upgraded main version is included in the vulnerable versions list), the upgraded main version is not installed (i.e., upgrade is not performed).

For downgrade of the SW/FW, the system receives another SW/FW install package for the lower version. The SW/FW install package includes a downgraded version of the SW/FW and a fallback version of the SW/FW. The system checks whether the downgraded main version of the SW/FW is vulnerable. The vulnerability of the downgraded main version may be determined by checking the vulnerable versions list included in the fallback version stored in the system (or the fallback version received in the new SW/FW install package if the received version is higher).

If the downgraded main version is determined to be not vulnerable (e.g., the downgraded main version is not included in the vulnerable versions list), then the downgraded main version is installed. If the downgraded main version is determined to be vulnerable (e.g., the downgraded main version is included in the vulnerable versions list), the downgraded main version is not installed (i.e., the downgrade fails). In this case, the system may maintain the existing version, or may install the fallback version (e.g., depending on the user's input). The existing fallback version may remain intact if the downgraded version has either the same fallback version or lower one.

In example schemes disclosed herein, the SW/FW delivery mechanism (e.g., a SW driver, installation tool, etc.) will fail to upload the vulnerable SW/FW image as the revoked version of the SW/FW will be detected by the OS via the vulnerable versions list as explained above and will not be updated or installed. In example schemes disclosed herein, if the vulnerable SW/FW versions are detected, the OS may use the fallback version of the SW/FW that is available to the OS to recover the install/update flow.

In examples, the fallback version of SW image will be secure and may provide full or partially-needed functionalities depending on the use case. The system in accordance with the example schemes disclosed herein will provide both security and UX/usability.

FIG. 2 is an example signal flow diagram for anti-rollback protection against a rollback attack in accordance with an example scheme disclosed herein. It is assumed that a SW version X+1, which is a good (not vulnerable) version of the SW, is currently installed on the system. The adversary is attempting to uninstall the good version of the SW (version X+1) (202) and load an old vulnerable version (version X) of the SW (204).

The OS checks whether the version X of the SW has been revoked (i.e., whether the version X is included in the vulnerable versions list that is currently stored in the system) (206). If it is determined that the version X has been revoked (i.e., version X is included in the vulnerable versions list), the OS starts recovery to the fallback version (208). The OS requests installation of the fallback version to the driver (210), and the driver downloads and installs the fallback version (212). The OS may notify the user about the installation of the limited version (fallback version) of the SW instead of the updated version (version X+1) (214).

In case of persistent FW, the FW delivery mechanism updates the existing FW (update flow). For recovery to the secure version, the update will fail, and the system remains with the existing FW. In case of a non-persistent FW, the FW delivery mechanism loads a new FW (init/start). For recovery to the secure version, a conventional solution is to prevent the FW from loading, which results in lack of critical desired functionalities. In contrast, in accordance with the examples disclosed herein, the FW update/install will fail and the system recovers to a fallback version.

As disclosed above, the fallback version includes a vulnerable versions list. In some examples, the fallback version may also include an allowed versions list in addition to the vulnerable versions list as metadata. The allowed versions list indicates the SW/FW versions that are allowed for installation or update. If the allowed versions list is included in the fallback version, the system may downgrade only to the version included in the allowed versions list. Whether to include the allowed versions list in the fallback version may depend on a policy. The allowed versions list may be included in the fallback version for security, functionality, etc. The vulnerable versions list and the allowed versions list may be updated by a newer fallback version.

An example for update of the vulnerable versions list and the allowed versions list is provided below. A SW package version 1.2 may be released as follows:
SW package version 1.2: main version 1.2+fallback version 1.2, and the fallback version 1.2 includes:
   FBv1.2 vulnerable versions list=D {0.1, 0.3, 0.7, 1.0, 1.1}, and
   FBv1.2 allowed versions list=A {0.2, 0.4, 0.6, 1.2, 1.3}.
      where D stands for deny (vulnerable versions) and A stands for allow (allowed versions).

A subsequent updated SW package 4.0 may be released as follows:
SW package 4.0: main version 4.0+fallback version 4.0, and
the fallback version 4.0 includes:
   FBv4.0 vulnerable versions list=D {0.1, 0.3, 0.7, 1.0, 1.1, 1.4, 1.8, 1.9, 2.0, 2.2, 2.7, 2.9, 3.0, 3.1, 3.9}, and
   FBv4.0 allowed versions list=A {0.2, 0.4, 0.6, 1.2, 1.3, 1.5, 1.6, 1.9, 2.1, 2.3, 2.6, 2.8, 3.3, 3.4, 3.5}.

A subsequent updated SW package 5.3 may be released as follows:
SW package 5.3: main version 5.3+fallback version 5.3, and
fallback version 5.3 includes:
   FBv5.3 vulnerable versions list=FBv4.0 vulnerable list plus D {4.0, 4.2, 4.8, 5.0}, and
   FBv5.3 allowed versions list=FBv4.0 allow list plus A {4.1, 4.3, 4.6, 4.7}.

In this way, every upgrade will increase the vulnerable versions list and improve the latest fallback version. For example, if a user reaches version 5.3, the system will no longer be able to downgrade to any version included in the vulnerable versions list 5.3, and may only downgrade to the version not included in the vulnerable versions list 5.3 (or only to the version included in the allowed versions list 5.3 (if provided)) or fallback to fallback version 5.3.

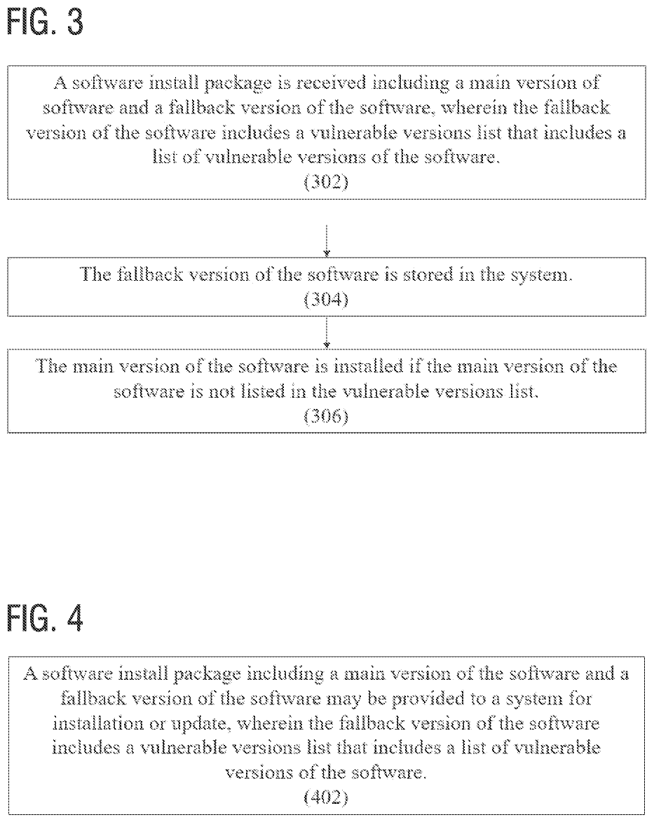

FIG. 3 is a flow diagram of an example process for anti-rollback protection for a non-persistent software in a system. A software install package is received (302). The software install package includes a main version of software and a fallback version of the software. The fallback version of the software includes a vulnerable versions list that includes a list of vulnerable versions of the software (which may have been determined up to a release date of the fallback version of the software). The fallback version of the software is stored in the system (304). The main version of the software is installed if the main version of the software is not listed in the vulnerable versions list (306).

The method may further include receiving a second software install package for upgrade or downgrade. The second software install package includes a second main version of the software and a second fallback version of the software. The second fallback version of the software includes a second vulnerable versions list that includes a list of vulnerable versions of the software determined up to a release date of the second fallback version of the software. The fallback version of the software stored in the system may be updated if the second fallback version of the software is a higher version than the fallback version of the software stored in the system. No change may be made to the fallback version of the software stored in the system if the second fallback version of the software is not a higher version than the fallback version of the software stored in the system. The second main version of the software may be installed if the second main version of the software is not included in the vulnerable versions list stored in the system, and may not installed in the system if the second main version of the software is included in the vulnerable versions list stored in the system.

The main version of the software may be uninstalled. In that case, the fallback version may remain in the system without any change after uninstalling the main version of the software.

Instead of the main version, the fallback version of the software may be installed if the main version of the software is listed in the vulnerable versions list.

In some examples, the fallback version of the software may be stored in a fallback versions' repository by an operating system or by a delivery mechanism. In some examples, the fallback version of the software may be stored in a secure storage in hardware or at operating system-protected registry hive.

In some examples, the fallback version of the software may further include an allowed versions list that indicates a version of the software that is allowed to be installed. The main version of the software may be installed only if the main version of the software is included in the allowed versions list.

In some examples, the software install package, the main version of the software, and the fallback version of the software may be each signed by a separate digital signature, and the main version of the software is installed and the fallback version of the software is stored in the system if the software install package, the main version of the software, and the fallback version of the software are all verified by the respective digital signature.

FIG. 4 is a flow diagram of an example process for anti-rollback protection for a non-persistent software in a system. In the example method, a software install package may be provided to a system for installation or update (402). The software install package may include a main version of software and a fallback version of the software. The fallback version of the software includes a vulnerable versions list that includes a list of vulnerable versions of the software determined up to a release date of the fallback version of the software.

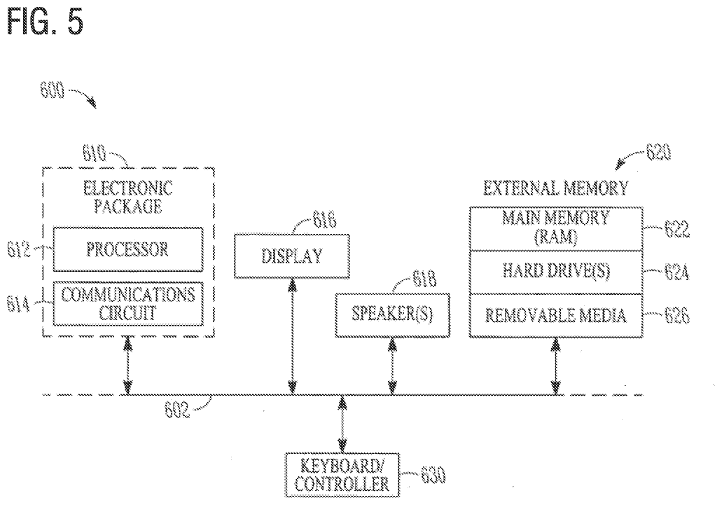

FIG. 5 is a block diagram of an electronic apparatus 600 incorporating at least one electronic assembly and/or method described herein. Electronic apparatus 600 is merely one example of an electronic apparatus in which forms of the electronic assemblies and/or methods described herein may be used. Examples of an electronic apparatus 600 include, but are not limited to, personal computers, tablet computers, mobile telephones, game devices, MP3 or other digital music players, etc. In this example, electronic apparatus 600 comprises a data processing system that includes a system bus 602 to couple the various components of the electronic apparatus 600. System bus 602 provides communications links among the various components of the electronic apparatus 600 and may be implemented as a single bus, as a combination of busses, or in any other suitable manner.

An electronic assembly 610 as describe herein may be coupled to system bus 602. The electronic assembly 610 may include any circuit or combination of circuits. In one embodiment, the electronic assembly 610 includes a processor 612 which can be of any type. As used herein, “processor” means any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, or any other type of processor or processing circuit.

Other types of circuits that may be included in electronic assembly 610 are a custom circuit, an application-specific integrated circuit (ASIC), or the like, such as, for example, one or more circuits (such as a communications circuit 614) for use in wireless devices like mobile telephones, tablet computers, laptop computers, two-way radios, and similar electronic systems. The IC can perform any other type of function.

The electronic apparatus 600 may also include an external memory 620, which in turn may include one or more memory elements suitable to the particular application, such as a main memory 622 in the form of random access memory (RAM), one or more hard drives 624, and/or one or more drives that handle removable media 626 such as compact disks (CD), flash memory cards, digital video disk (DVD), and the like.

The electronic apparatus 600 may also include a display device 616, one or more speakers 618, and a keyboard and/or controller 630, which can include a mouse, trackball, touch screen, voice-recognition device, or any other device that permits a system user to input information into and receive information from the electronic apparatus 600.

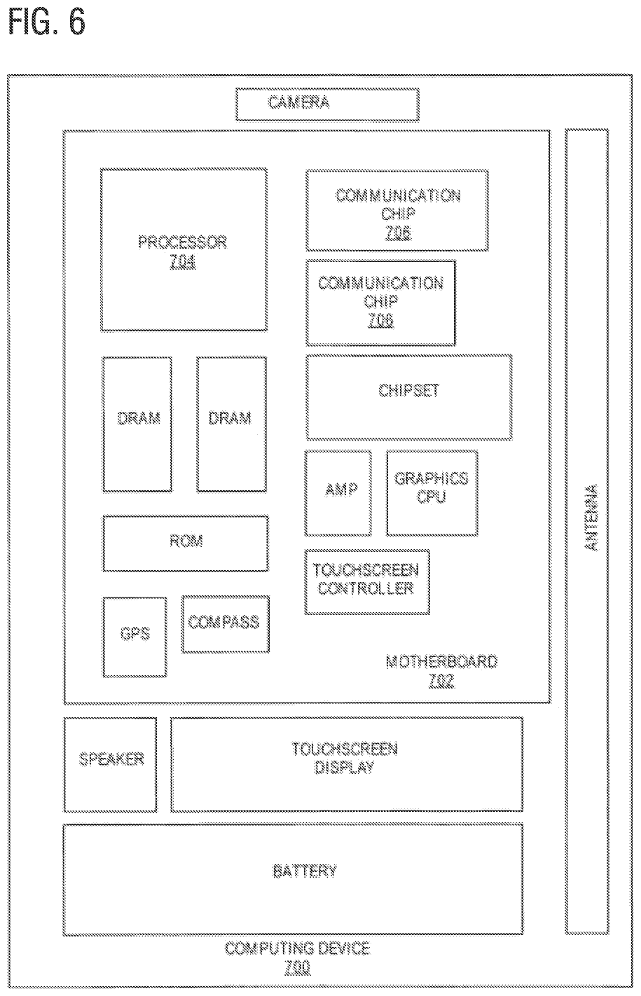

FIG. 6 illustrates a computing device 700 in accordance with one implementation of the invention. The computing device 700 houses a board 702. The board 702 may include a number of components, including but not limited to a processor 704 and at least one communication chip 706. The processor 704 is physically and electrically coupled to the board 702. In some implementations the at least one communication chip 706 is also physically and electrically coupled to the board 702. In further implementations, the communication chip 706 is part of the processor 704. Depending on its applications, computing device 700 may include other components that may or may not be physically and electrically coupled to the board 702. These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth). The communication chip 706 enables wireless communications for the transfer of data to and from the computing device 700. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 706 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 700 may include a plurality of communication chips 706. For instance, a first communication chip 706 may be dedicated to shorter range wireless communications such as Wi-Fi and Bluetooth and a second communication chip 706 may be dedicated to longer range wireless communications such as GPS, EDGE, GPRS, CDMA, WiMAX, LTE, Ev-DO, and others. The processor 704 of the computing device 700 includes an integrated circuit die packaged within the processor 704. In some implementations of the invention, the integrated circuit die of the processor includes one or more devices that are assembled in an ePLB or eWLB based POP package that that includes a mold layer directly contacting a substrate, in accordance with implementations of the invention. The term “processor” may refer to any device or portion of a device that processes electronic data from registers and/or memory to transform that electronic data into other electronic data that may be stored in registers and/or memory. The communication chip 706 also includes an integrated circuit die packaged within the communication chip 706. In accordance with another implementation of the invention, the integrated circuit die of the communication chip includes one or more devices that are assembled in an ePLB or eWLB based POP package that that includes a mold layer directly contacting a substrate, in accordance with implementations of the invention.

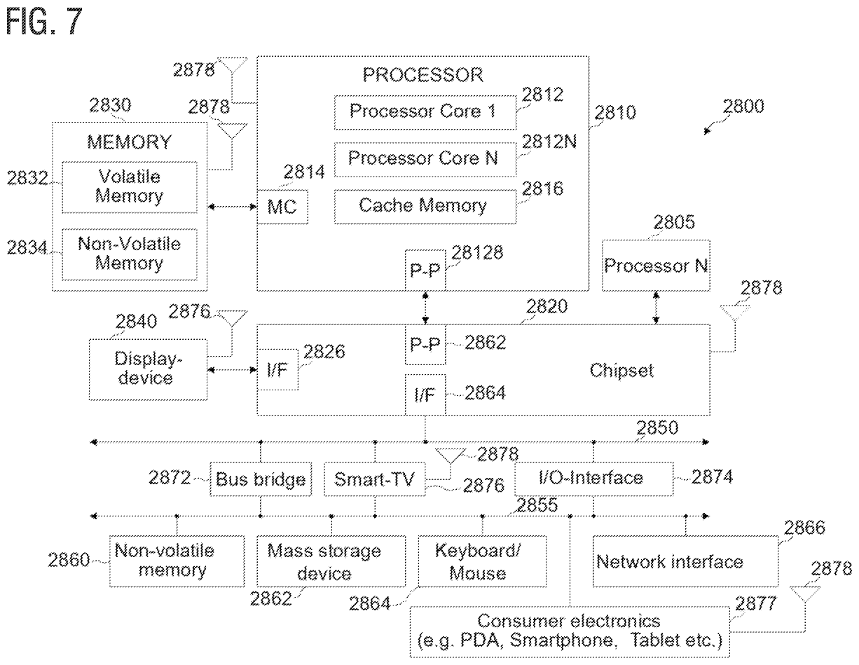

FIG. 7 is included to show an example of a higher-level device application for the disclosed embodiments. The MAA cantilevered heat pipe apparatus embodiments may be found in several parts of a computing system. In an embodiment, the MAA cantilevered heat pipe is part of a communications apparatus such as is affixed to a cellular communications tower. The MAA cantilevered heat pipe may also be referred to as an MAA apparatus. In an embodiment, a computing system 2800 includes, but is not limited to, a desktop computer. In an embodiment, a system 2800 includes, but is not limited to a laptop computer. In an embodiment, a system 2800 includes, but is not limited to a netbook. In an embodiment, a system 2800 includes, but is not limited to a tablet. In an embodiment, a system 2800 includes, but is not limited to a notebook computer. In an embodiment, a system 2800 includes, but is not limited to a personal digital assistant (PDA). In an embodiment, a system 2800 includes, but is not limited to a server. In an embodiment, a system 2800 includes, but is not limited to a workstation. In an embodiment, a system 2800 includes, but is not limited to a cellular telephone. In an embodiment, a system 2800 includes, but is not limited to a mobile computing device. In an embodiment, a system 2800 includes, but is not limited to a smart phone. In an embodiment, a system 2800 includes, but is not limited to an internet appliance. Other types of computing devices may be configured with the microelectronic device that includes MAA apparatus embodiments.

In an embodiment, the processor 2810 has one or more processing cores 2812 and 2812N, where 2812N represents the Nth processor core inside processor 2810 where N is a positive integer. In an embodiment, the electronic device system 2800 using a MAA apparatus embodiment that includes multiple processors including 2810 and 2805, where the processor 2805 has logic similar or identical to the logic of the processor 2810. In an embodiment, the processing core 2812 includes, but is not limited to, pre-fetch logic to fetch instructions, decode logic to decode the instructions, execution logic to execute instructions and the like. In an embodiment, the processor 2810 has a cache memory 2816 to cache at least one of instructions and data for the MAA apparatus in the system 2800. The cache memory 2816 may be organized into a hierarchal structure including one or more levels of cache memory.

In an embodiment, the processor 2810 includes a memory controller 2814, which is operable to perform functions that enable the processor 2810 to access and communicate with memory 2830 that includes at least one of a volatile memory 2832 and a non-volatile memory 2834. In an embodiment, the processor 2810 is coupled with memory 2830 and chipset 2820. The processor 2810 may also be coupled to a wireless antenna 2878 to communicate with any device configured to at least one of transmit and receive wireless signals. In an embodiment, the wireless antenna interface 2878 operates in accordance with, but is not limited to, the IEEE 802.11 standard and its related family, Home Plug AV (HPAV), Ultra Wide Band (UWB), Bluetooth, WiMax, or any form of wireless communication protocol.

In an embodiment, the volatile memory 2832 includes, but is not limited to, Synchronous Dynamic Random Access Memory (SDRAM), Dynamic Random Access Memory (DRAM), RAMBUS Dynamic Random Access Memory (RDRAM), and/or any other type of random access memory device. The non-volatile memory 2834 includes, but is not limited to, flash memory, phase change memory (PCM), read-only memory (ROM), electrically erasable programmable read-only memory (EEPROM), or any other type of non-volatile memory device.

The memory 2830 stores information and instructions to be executed by the processor 2810. In an embodiment, the memory 2830 may also store temporary variables or other intermediate information while the processor 2810 is executing instructions. In the illustrated embodiment, the chipset 2820 connects with processor 2810 via Point-to-Point (PtP or P-P) interfaces 2817 and 2822. Either of these PtP embodiments may be achieved using a MAA apparatus embodiment as set forth in this disclosure. The chipset 2820 enables the processor 2810 to connect to other elements in the MAA apparatus embodiments in a system 2800. In an embodiment, interfaces 2817 and 2822 operate in accordance with a PtP communication protocol such as the Intel® QuickPath Interconnect (QPI) or the like. In other embodiments, a different interconnect may be used.

In an embodiment, the chipset 2820 is operable to communicate with the processor 2810, 2805N, the display device 2840, and other devices 2872, 2876, 2874, 2860, 2862, 2864, 2866, 2877, etc. The chipset 2820 may also be coupled to a wireless antenna 2878 to communicate with any device configured to at least do one of transmit and receive wireless signals.

The chipset 2820 connects to the display device 2840 via the interface 2826. The display 2840 may be, for example, a liquid crystal display (LCD), a plasma display, cathode ray tube (CRT) display, or any other form of visual display device. In and embodiment, the processor 2810 and the chipset 2820 are merged into a MAA apparatus in a system. Additionally, the chipset 2820 connects to one or more buses 2850 and 2855 that interconnect various elements 2874, 2860, 2862, 2864, and 2866. Buses 2850 and 2855 may be interconnected together via a bus bridge 2872 such as at least one MAA apparatus embodiment. In an embodiment, the chipset 2820 couples with a non-volatile memory 2860, a mass storage device(s) 2862, a keyboard/mouse 2864, and a network interface 2866 by way of at least one of the interface 2824 and 2874, the smart TV 2876, and the consumer electronics 2877, etc.

In an embodiment, the mass storage device 2862 includes, but is not limited to, a solid state drive, a hard disk drive, a universal serial bus flash memory drive, or any other form of computer data storage medium. In one embodiment, the network interface 2866 is implemented by any type of well-known network interface standard including, but not limited to, an Ethernet interface, a universal serial bus (USB) interface, a Peripheral Component Interconnect (PCI) Express interface, a wireless interface and/or any other suitable type of interface. In one embodiment, the wireless interface operates in accordance with, but is not limited to, the IEEE 802.11 standard and its related family, Home Plug AV (HPAV), Ultra Wide Band (UWB), Bluetooth, WiMax, or any form of wireless communication protocol.

While the modules shown in FIG. 8 are depicted as separate blocks within the MAA apparatus embodiment in a computing system 2800, the functions performed by some of these blocks may be integrated within a single semiconductor circuit or may be implemented using two or more separate integrated circuits. For example, although cache memory 2816 is depicted as a separate block within processor 2810, cache memory 2816 (or selected aspects of 2816) can be incorporated into the processor core 2812.

Where useful, the computing system 2800 may have a broadcasting structure interface such as for affixing the MAA apparatus to a cellular tower.

Another example is a computer program having a program code for performing at least one of the methods described herein, when the computer program is executed on a computer, a processor, or a programmable hardware component. Another example is a machine-readable storage including machine readable instructions, when executed, to implement a method or realize an apparatus as described herein. A further example is a machine-readable medium including code, when executed, to cause a machine to perform any of the methods described herein.

The examples as described herein may be summarized as follows:

An example (e.g., example 1) relates to a method for anti-rollback protection for a non-persistent software in a system. The method includes receiving a software install package, wherein the software install package includes a main version of software and a fallback version of the software, and the fallback version of the software includes a vulnerable versions list that includes a list of vulnerable versions of the software; storing the fallback version of the software in the system; and installing the main version of the software if the main version of the software is not listed in the vulnerable versions list.

Another example, (e.g., example 2) relates to a previously described example (e.g., example 1), wherein the method further includes receiving a second software install package, wherein the second software install package includes a second main version of the software and a second fallback version of the software, and the second fallback version of the software includes a second vulnerable versions list that includes a list of vulnerable versions of the software; and updating the fallback version of the software stored in the system if the second fallback version of the software is a higher version than the fallback version of the software stored in the system. N change may be made to the fallback version of the software stored in the system if the second fallback version of the software is not a higher version than the fallback version of the software stored in the system.

Another example, (e.g., example 3) relates to a previously described example (e.g., example 2), wherein the method further includes installing the second main version of the software if the second main version of the software is not included in the vulnerable versions list stored in the system. The second main version of the software is not installed in the system if the second main version of the software is included in the vulnerable versions list stored in the system.

Another example, (e.g., example 4) relates to a previously described example (e.g., any one of examples 1-3), wherein the method further includes uninstalling the main version of the software. The fallback version remains in the system without any change after uninstalling the main version of the software.

Another example, (e.g., example 5) relates to a previously described example (e.g., any one of examples 1-4), wherein the method further includes installing the fallback version of the software if the main version of the software is listed in the vulnerable versions list.

Another example, (e.g., example 6) relates to a previously described example (e.g., any one of examples 1-5), wherein the fallback version of the software is stored in a fallback versions' repository by an operating system.

Another example, (e.g., example 7) relates to a previously described example (e.g., any one of examples 1-5), wherein the fallback version of the software is stored in a secure storage in hardware or at operating system-protected registry hive.

Another example, (e.g., example 8) relates to a previously described example (e.g., any one of examples 1-7), wherein the fallback version of the software further includes an allowed versions list that includes a version of the software that is allowed to be installed, wherein the main version of the software is installed if the main version of the software is included in the allowed versions list.

Another example, (e.g., example 9) relates to a previously described example (e.g., any one of examples 1-8), wherein the software install package, the main version of the software, and the fallback version of the software are each signed by a separate digital signature, wherein the main version of the software is installed and the fallback version of the software is stored in the system if the software install package, the main version of the software, and the fallback version of the software are all verified by the respective digital signature.

Another example, (e.g., example 10) relates to an apparatus for anti-rollback protection for a non-persistent software. The apparatus includes processing circuitry and a storage. The processing circuitry is configured to receive a software install package. The software install package includes a main version of software and a fallback version of the software, and the fallback version of the software includes a vulnerable versions list that includes a list of vulnerable versions of the software. The storage is configured to store the fallback version of the software. The processing circuitry is configured to install the main version of the software if the main version of the software is not listed in the vulnerable versions list.

Another example, (e.g., example 11) relates to a previously described example (e.g., example 10), wherein the processing circuitry is configured to receive a second software install package, wherein the second software install package includes a second main version of the software and a second fallback version of the software, and the second fallback version of the software includes a second vulnerable versions list that includes a list of vulnerable versions of the software. The processing circuitry is configured to update the fallback version of the software stored in the storage if the second fallback version of the software is a higher version than the fallback version of the software stored in the storage, and make no change to the fallback version of the software stored in the storage if the second fallback version of the software is not a higher version than the fallback version of the software stored in the storage.

Another example, (e.g., example 12) relates to a previously described example (e.g., example 11), wherein the processing circuitry is configured to install the second main version of the software if the second main version of the software is not included in the vulnerable versions list stored in the storage, and not install the second main version of the software if the second main version of the software is included in the vulnerable versions list stored in the storage.

Another example, (e.g., example 13) relates to a previously described example (e.g., any one of examples 10-12), wherein the processing circuitry is configured to uninstall the main version of the software. The fallback version remains in the storage without any change after uninstalling the main version of the software.

Another example, (e.g., example 14) relates to a previously described example (e.g., any one of examples 10-13), wherein the processing circuitry is configured to install the fallback version of the software if the main version of the software is listed in the vulnerable versions list.

Another example, (e.g., example 15) relates to a previously described example (e.g., any one of examples 10-14), wherein the fallback version of the software is stored in a fallback versions' repository by an operating system.

Another example, (e.g., example 16) relates to a previously described example (e.g., any one of examples 10-15), wherein the fallback version of the software is stored in a secure storage in hardware or at operating system-protected registry hive.

Another example, (e.g., example 17) relates to a previously described example (e.g., any one of examples 10-16), wherein the fallback version of the software further includes an allowed versions list that indicates a version of the software that is allowed to be installed, wherein the processing circuitry is configured to install the main version of the software if the main version of the software is included in the allowed versions list.

Another example, (e.g., example 18) relates to a previously described example (e.g., any one of examples 10-17), wherein the software install package, the main version of the software, and the fallback version of the software are each signed by a separate digital signature, wherein the processing circuitry is configured to install the main version of the software and store the fallback version of the software in the storage if the software install package, the main version of the software, and the fallback version of the software are all verified by the respective digital signature.

Another example, (e.g., example 19) relates to a method for anti-rollback protection for a non-persistent software in a system. The method includes providing a software install package. The software install package includes a main version of software and a fallback version of the software, and the fallback version of the software includes a vulnerable versions list that includes a list of vulnerable versions of the software.

Another example, (e.g., example 20) relates to a non-transitory machine-readable medium including code, when executed, to cause a machine to perform the method as in any one of examples 1-9 and 19.

Another example, (e.g., example 21) relates to a computer program having a program code for performing the method as in any one of examples 1-9 and 19, when the computer program is executed on a computer, a processor, or a programmable hardware component.

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F)PLAs) or (field) programmable gate arrays ((F)PGAs), programmed to perform the acts of the above-described methods.

The description and drawings merely illustrate the principles of the disclosure. Furthermore, all examples recited herein are principally intended expressly to be only for pedagogical purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a sensor signal”, “means for generating a transmit signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software but may include digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions or computer program products as well as any data created and/or used during implementation of the disclosed technologies can be stored on one or more tangible or non-transitory computer-readable storage media, such as volatile memory (e.g., DRAM, SRAM), non-volatile memory (e.g., flash memory, chalcogenide-based phase-change non-volatile memory) optical media discs (e.g., DVDs, CDs), and magnetic storage (e.g., magnetic tape storage, hard disk drives). Computer-readable storage media can be contained in computer-readable storage devices such as solid-state drives, USB flash drives, and memory modules. Alternatively, any of the methods disclosed herein (or a portion) thereof may be performed by hardware components comprising non-programmable circuitry. In some examples, any of the methods herein can be performed by a combination of non-programmable hardware components and one or more processing units executing computer-executable instructions stored on computer-readable storage media.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C#, Java, Perl, Python, JavaScript, Adobe Flash, C#, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

As used in this application and the claims, a list of items joined by the term “and/or” can mean any combination of the listed items. For example, the phrase “A, B and/or C” can mean A; B; C; A and B; A and C; B and C; or A, B and C. As used in this application and the claims, a list of items joined by the term “at least one of” can mean any combination of the listed terms. For example, the phrase “at least one of A, B or C” can mean A; B; C; A and B; A and C; B and C; or A, B, and C. Moreover, as used in this application and the claims, a list of items joined by the term “one or more of” can mean any combination of the listed terms. For example, the phrase “one or more of A, B and C” can mean A; B; C; A and B; A and C; B and C; or A, B, and C.

The disclosed methods, apparatuses, and systems are not to be construed as limiting in any way. Instead, the present disclosure is directed toward all novel and nonobvious features and aspects of the various disclosed examples, alone and in various combinations and sub-combinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

1. A method for anti-rollback protection for a non-persistent software in a system, comprising:
receiving a software install package, wherein the software install package includes a main version of software and a fallback version of the software, and the fallback version of the software includes a vulnerable versions list that includes a list of vulnerable versions of the software;
storing the fallback version of the software in the system; and
installing the main version of the software if the main version of the software is not listed in the vulnerable versions list.

2. The method of claim 1, further comprising:
receiving a second software install package, wherein the second software install package includes a second main version of the software and a second fallback version of the software, and the second fallback version of the software includes a second vulnerable versions list that includes a list of vulnerable versions of the software; and
updating the fallback version of the software stored in the system if the second fallback version of the software is a higher version than the fallback version of the software stored in the system,
wherein no change is made to the fallback version of the software stored in the system if the second fallback version of the software is not a higher version than the fallback version of the software stored in the system.

3. The method of claim 2, further comprising:
installing the second main version of the software if the second main version of the software is not included in the vulnerable versions list stored in the system,
wherein the second main version of the software is not installed in the system if the second main version of the software is included in the vulnerable versions list stored in the system.

4. The method of claim 1, further comprising:
uninstalling the main version of the software, wherein the fallback version remains in the system without any change after uninstalling the main version of the software.

5. The method of claim 1, further comprising:
installing the fallback version of the software if the main version of the software is listed in the vulnerable versions list.

6. The method of claim 1, wherein the fallback version of the software is stored in a fallback versions' repository by an operating system.

7. The method of claim 1, wherein the fallback version of the software is stored in a secure storage in hardware or at operating system-protected registry hive.

8. The method of claim 1, wherein the fallback version of the software further includes an allowed versions list that includes a version of the software that is allowed to be installed, wherein the main version of the software is installed if the main version of the software is included in the allowed versions list.

9. The method of claim 1, wherein the software install package, the main version of the software, and the fallback version of the software are each signed by a separate digital signature, wherein the main version of the software is installed and the fallback version of the software is stored in the system if the software install package, the main version of the software, and the fallback version of the software are all verified by the respective digital signature.

10. An apparatus for anti-rollback protection for a non-persistent software, comprising:
processing circuitry configured to receive a software install package, wherein the software install package includes a main version of software and a fallback version of the software, and the fallback version of the software includes a vulnerable versions list that includes a list of vulnerable versions of the software; and
a storage configured to store the fallback version of the software,
wherein the processing circuitry is configured to install the main version of the software if the main version of the software is not listed in the vulnerable versions list.

11. The apparatus of claim 10, wherein the processing circuitry is configured to receive a second software install package, wherein the second software install package includes a second main version of the software and a second fallback version of the software, and the second fallback version of the software includes a second vulnerable versions list that includes a list of vulnerable versions of the software,
wherein the processing circuitry is configured to update the fallback version of the software stored in the storage if the second fallback version of the software is a higher version than the fallback version of the software stored in the storage, and make no change to the fallback version of the software stored in the storage if the second fallback version of the software is not a higher version than the fallback version of the software stored in the storage.

12. The apparatus of claim 11, wherein the processing circuitry is configured to install the second main version of the software if the second main version of the software is not included in the vulnerable versions list stored in the storage, and not install the second main version of the software if the second main version of the software is included in the vulnerable versions list stored in the storage.

13. The apparatus of claim 10, wherein the processing circuitry is configured to uninstall the main version of the software, wherein the fallback version remains in the storage without any change after uninstalling the main version of the software.

14. The apparatus of claim 10, wherein the processing circuitry is configured to install the fallback version of the software if the main version of the software is listed in the vulnerable versions list.

15. The apparatus of claim 10, wherein the fallback version of the software is stored in a fallback versions' repository by an operating system.

16. The apparatus of claim 10, wherein the fallback version of the software is stored in a secure storage in hardware or at operating system-protected registry hive.

17. The apparatus of claim 10, wherein the fallback version of the software further includes an allowed versions list that indicates a version of the software that is allowed to be installed, wherein the processing circuitry is configured to install the main version of the software if the main version of the software is included in the allowed versions list.

18. The apparatus of claim 10, wherein the software install package, the main version of the software, and the fallback version of the software are each signed by a separate digital signature, wherein the processing circuitry is configured to install the main version of the software and store the fallback version of the software in the storage if the software install package, the main version of the software, and the fallback version of the software are all verified by the respective digital signature.

19. A method for anti-rollback protection for a non-persistent software in a system, comprising:
providing a software install package, wherein the software install package includes a main version of software and a fallback version of the software, and the fallback version of the software includes a vulnerable versions list that includes a list of vulnerable versions of the software.

20. A non-transitory machine-readable medium including code, when executed, to cause a machine to perform a method of claim 1.
